(19) United States
(12) Patent Application Publication
(10) Pub. No.: US 2025/0332971 A1
(43) Pub. Date: Oct. 30, 2025

(54) BLOWER MOUNTING STRUCTURE FOR VEHICLE SEAT AND VEHICLE SEAT

(71) Applicant: NHK SPRING CO., LTD., Yokohama-shi (JP)

(72) Inventors: Junichi TAKADA, Yokohama-shi (JP); Motohiro FUSHIKIDA, Yokohama-shi (JP)

(21) Appl. No.: 19/186,272

(22) Filed: Apr. 22, 2025

(30) Foreign Application Priority Data
Apr. 25, 2024 (JP) 2024-071712

(51) Int. Cl. B60N 2/56; B60N 2/90

(52) U.S. Cl. CPC B60N 2/5642; B60N 2/933

(57) ABSTRACT

In a blower mounting structure for a vehicle seat, a blower mounting member disposed in a seat back is provided with a blower mounting hole and a protrusion. A blower is mounted to the blower mounting member by being subjected to rotation in one direction about an axis of the blower mounting hole in a state of being fitted into the blower mounting hole, and has a lock portion locked to the projection by the rotation. The center of gravity of the blower is set at a position at which a rotational force in one direction about the axis acts on the blower.

### CROSS-REFERENCE TO RELATED APPLICATION

This application is based on and claims priority under 35 USC 119 from Japanese Patent Application No. 2024-071712 filed on Apr. 25, 2024, the disclosure of which is incorporated by reference herein.

### BACKGROUND

### Technical Field

The present disclosure relates to a vehicle seat, and more particularly to a blower mounting structure for a vehicle seat.

### Related Art

In a vehicle seat disclosed in Japanese Patent Application Laid-Open (JP-A) No. 2022-126803, an air-conditioning blower is fixed to a bracket mounted to a seat back frame.

### SUMMARY

Some blowers mounted on a vehicle seat are configured to be rotated and locked with respect to a bracket (blower mounting member). In such a configuration, when the center of gravity of the blower is deviated from the rotation center of the blower with respect to the blower mounting member, the blower may rotate with respect to the blower mounting member due to vibration or the like during traveling of the vehicle, and the lock of the blower with respect to the blower mounting member may be unlocked.

An object of the present disclosure is to provide a blower mounting structure for a vehicle seat and a vehicle seat capable of preventing a blower from being unlocked from a blower mounting member due to vibration or the like during traveling of a vehicle.

A blower mounting structure for a vehicle seat according to a first aspect of the present disclosure includes a blower mounting member disposed in a seat back frame of the vehicle seat and provided with a blower mounting hole and a locking portion, and a blower that is mounted to the blower mounting member by being subjected to rotation in one direction about an axis of the blower mounting hole in a state of being fitted into the blower mounting hole, and having a lock portion that is locked to the locking portion by the rotation, in which a center of gravity of the blower is set at a position at which a rotational force in the one direction about the axis acts on the blower.

In the blower mounting structure for a vehicle seat according to the first aspect, a blower mounting hole and a locking portion are provided in the blower mounting member disposed in the seat back of the vehicle seat. The blower is fitted into the blower mounting hole. The blower is mounted to the blower mounting member by being subjected to rotation in one direction about the axis of the blower mounting hole in a state of being fitted into the blower mounting hole. By this rotation, the lock portion provided in the blower is locked to the locking portion of the blower mounting member. The center of gravity of the blower is set at a position at which a rotational force in one direction about the axis acts on the blower. Thus, when vibration or the like during traveling of the vehicle is applied to the blower, the blower attempts to rotate about the axis with respect to the blower mounting member in one direction (that is, a direction in which the lock portion is locked to the locking portion). Therefore, it is possible to prevent the blower from being unlocked from the blower mounting member.

A blower mounting structure for a vehicle seat according to a second aspect is configured such that, in the first aspect, the locking portion is a projection, the lock portion has an elongated hole, and the projection is inserted into one end of the elongated hole in a longitudinal direction of the hole when the blower is fitted into the blower mounting hole, and the projection is held at another end of the elongated hole in the longitudinal direction by being disposed, by the rotation, at the another end of the elongated hole in the longitudinal direction.

With the blower mounting structure of the vehicle seat of the second aspect, when the blower is fitted into the blower mounting hole of the blower mounting member, the projection provided on the blower mounting member is inserted into one end of the elongated hole in the longitudinal direction included in the lock portion. When the blower is rotated in one direction about the axis of the blower mounting hole, the projection is disposed at another end of the elongated hole in the longitudinal direction, and the projection is held at the other end of the elongated hole in the longitudinal direction. With such a configuration, when the blower is fitted into the blower mounting hole, the blower can be disposed at a fitting position with respect to the blower mounting hole by aligning one end of the elongated hole in the longitudinal direction with the position of the projection. As a result, it is easy to attach the blower to the blower mounting member.

A vehicle seat according to a third aspect includes a seat cushion on which an occupant is seated, and a seat back that supports a back of the occupant and that has the blower mounting structure for a vehicle seat according to the first aspect or the second aspect.

In the vehicle seat according to the third aspect, the back of the occupant seated on the seat cushion is supported by the seat back. Since the seat back has the blower mounting structure for the vehicle seat of the first aspect or the second aspect, the above-described effect can be obtained.

As described above, according to the disclosure, it is possible to prevent the blower from being unlocked from the blower mounting member due to vibration or the like during traveling of the vehicle.

### BRIEF DESCRIPTION OF THE DRAWINGS

Exemplary embodiments of the present invention will be described in detail based on the following figures, wherein:

FIG. 1 is a side view illustrating a vehicle seat according to an embodiment;

FIG. 2 is a perspective view illustrating an air conditioning duct provided in a seat back of the vehicle seat according to the embodiment as viewed from a seat front side;

FIG. 3 is a perspective view illustrating the duct and the blower as viewed from a seat rear side;

FIG. 4 is a perspective view illustrating a state in which the blower is removed from the duct;

FIG. 5 is a perspective view illustrating a blower mounting member provided in the duct as viewed from the seat rear side;

FIG. 6 is a perspective view illustrating the blower mounting member as viewed from the seat front side;

FIG. 7 is a perspective view illustrating the blower as viewed from the seat rear side;

FIG. 8 is a perspective view illustrating the blower as viewed from the seat front side;

FIG. 9 is a first perspective view illustrating a part of the blower;

FIG. 10 is a second perspective view illustrating a part of the blower;

FIG. 11 is a rear view of the blower mounting member in the middle of mounting of the blower to the blower mounting member as viewed from the seat rear side; and

FIG. 12 is a rear view of the blower mounting member in a completely mounted state of the blower as viewed from the seat rear side.

### DETAILED DESCRIPTION

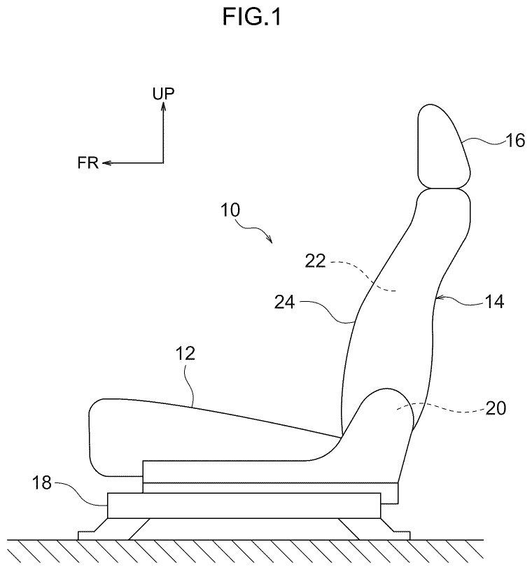

Hereinafter, a vehicle seat 10 according to an embodiment of the present disclosure will be described with reference to FIGS. 1 to 12. In each drawing, some reference numerals may be omitted in order to make the drawing easy to see. Arrows FR, LH, RH, and UP appropriately illustrated in the drawings indicate a front side, a left side, a right side, and an upper side of the vehicle seat 10, respectively. Hereinafter, when simply described using the front, rear, left, right, and up and down directions, directions with respect to the vehicle seat 10 are indicated.

As illustrated in FIG. 1, a vehicle seat 10 according to the present embodiment is, for example, a front seat of a vehicle, and includes a seat cushion 12 on which an occupant is seated, a seat back 14 that supports the back of the occupant, and a headrest 16 that supports the head of the occupant. The seat cushion 12 is connected to the floor of the vehicle via a known slide mechanism 18. A lower end of the seat back 14 is connected to a rear end of the seat cushion 12 via a known reclining mechanism 20. The headrest 16 is coupled to an upper end of the seat back 14 so as to be adjustable in vertical position.

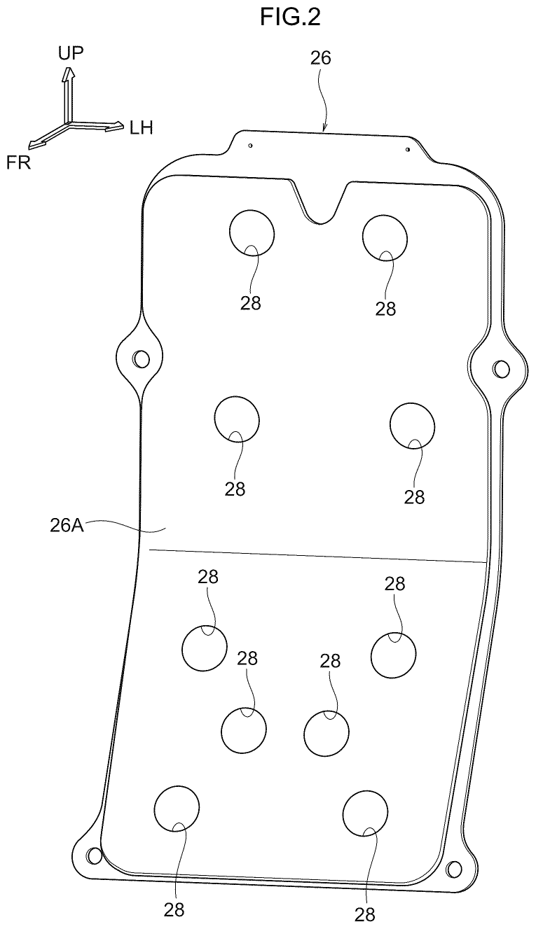

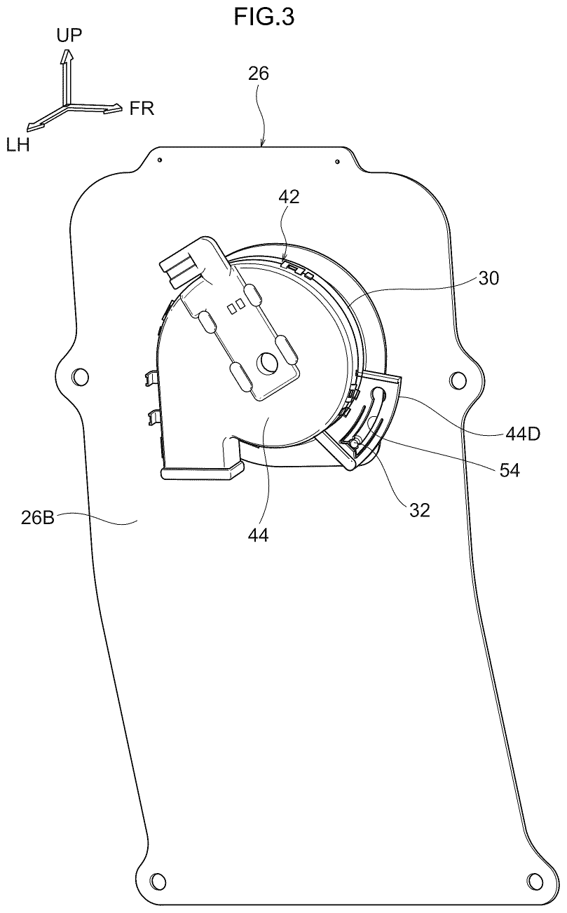

The seat back 14 includes a seat back frame (not illustrated) as a frame member, a seat back pad 22 as a cushion material, a trim cover 24 as a skin material, an air-conditioning duct 26 (see FIGS. 2 to 4) mounted to the seat back frame, and a blower 42 (see FIG. 3) mounted to the duct 26.

The seat back frame is formed by, for example, a press-molded metal plate. The seat back pad 22 is formed by foam such as urethane foam, for example, and covers the seat back frame from above. The trim cover 24 is formed in a bag shape by sewing plural skin pieces made of, for example, a cloth material, leather, synthetic leather, or the like, and covers the seat back pad 22 from above.

The duct 26 is formed by, for example, a cloth material such as a nonwoven fabric, and is formed in a long and thin bag shape. The duct 26 is disposed in the seat back 14 with a vertical direction as a longitudinal direction and a front-rear direction as a thickness direction. An air flow path for air conditioning is formed inside the duct 26. A front surface portion 26A of the duct 26 is in contact with a back surface of the seat back pad 22.

As illustrated in FIG. 2, plural intake holes 28 are formed in the front surface portion 26A of the duct 26. Although not illustrated, plural vent holes are formed in the seat back pad 22 at positions facing the plural intake holes 28. The plural intake holes 28 communicate with a front surface of the seat back pad 22 through the plural air vent holes.

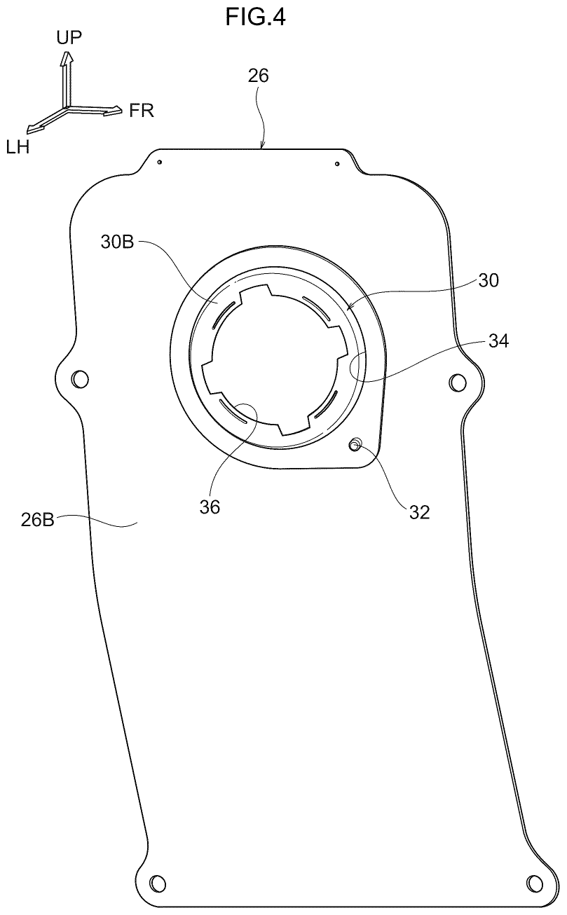

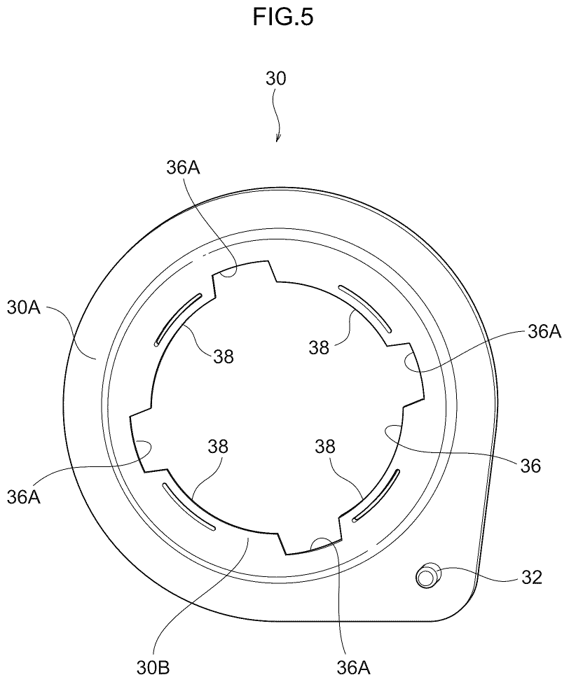

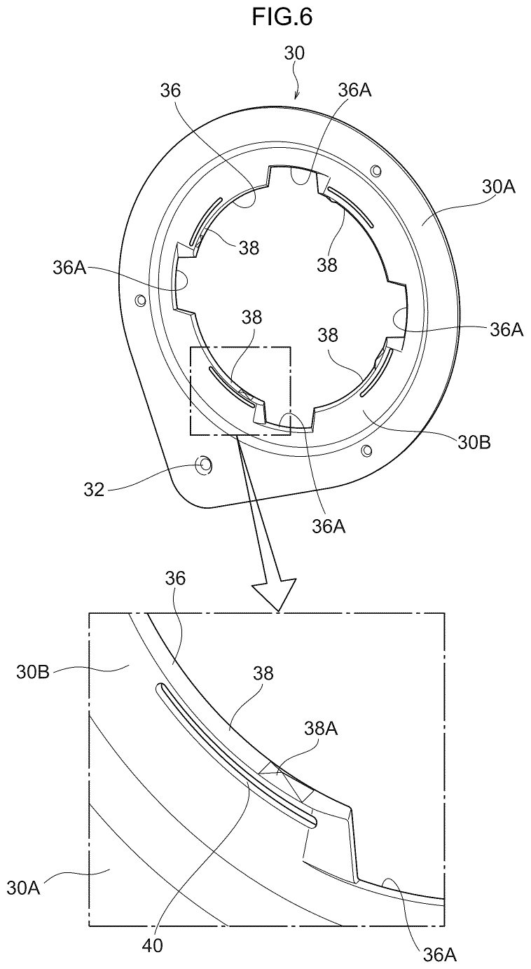

As illustrated in FIG. 4, a blower mounting member 30 is provided on an upper portion of the back surface portion 26B of the duct 26. The blower mounting member 30 is manufactured by, for example, injection molding of resin, and is formed in a ring-shaped plate shape as illustrated in FIGS. 5 and 6. The blower mounting member 30 is disposed with the front-rear direction as a plate thickness direction. The blower mounting member 30 constitutes a “blower mounting structure for a vehicle seat” according to the disclosure together with the blower 42.

A portion on an outer peripheral side of the blower mounting member 30 is a flange portion 30A. The flange portion 30A is disposed inside the duct 26 and is fixed to the back surface portion 26B of the duct 26 by adhesion or the like. A projection 32 that penetrates the back surface portion 26B of the duct 26 and protrudes to the rear side of the duct 26 is provided in a part (here, a lower right portion) of the flange portion 30A. The projection 32 has a substantially columnar shape whose axial direction is the front-rear direction. The projection 32 corresponds to a “locking portion” in the disclosure.

A portion of an inner peripheral side of the blower mounting member 30 is a blower mounting portion 30B protruding rearward from the flange portion 30A. Corresponding to the blower mounting portion 30B, a through hole 34 having a circular shape as viewed in the front-rear direction is formed in the back surface portion 26B of the duct 26. The blower mounting portion 30B is fitted in the through hole 34 and exposed to the rear side of the duct 26.

In a center portion of the blower mounting portion 30B, a blower mounting hole 36 having a substantially circular shape as viewed in the front-rear direction is formed. In a hole edge portion of the blower mounting hole 36, plural (here, four) cutouts 36A are formed. The plural cutouts 36A have a substantially rectangular shape with a circumferential direction of the blower mounting hole 36 as a longitudinal direction, and are arranged side by side at equal intervals in the circumferential direction of the blower mounting hole 36.

As illustrated in FIGS. 5 and 6, plural (here, four) blower locking portions 38 are provided at the hole edge portion of the blower mounting hole 36 between the plural cutouts 36A. On each blower locking portion 38, a protrusion 38A protruding inward in a radial direction of the blower mounting hole 36 is formed. In the hole edge portion of the blower mounting hole 36, a slit 40 extending in the circumferential direction of the blower mounting hole 36 is formed on a radially outer side with respect to each blower locking portion 38. Thus, each blower locking portion 38 is easily elastically deformed radially outward of the blower mounting hole 36.

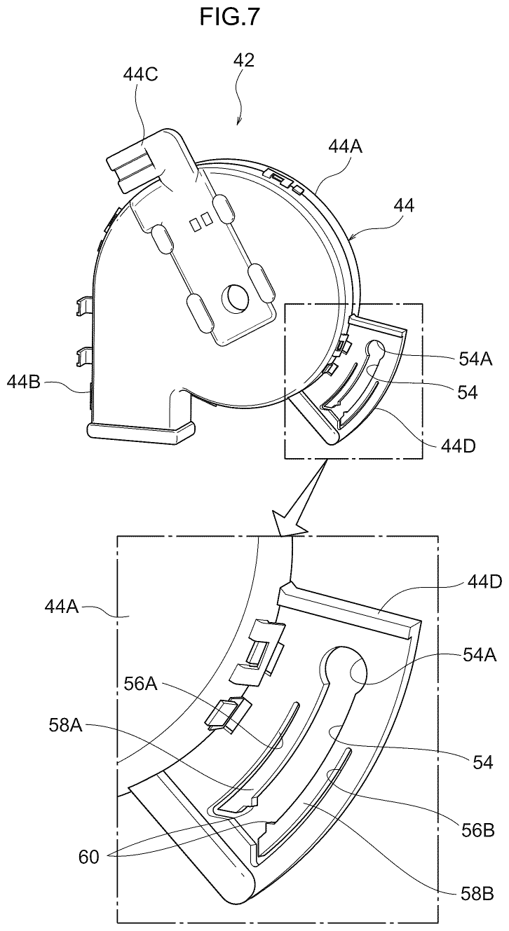

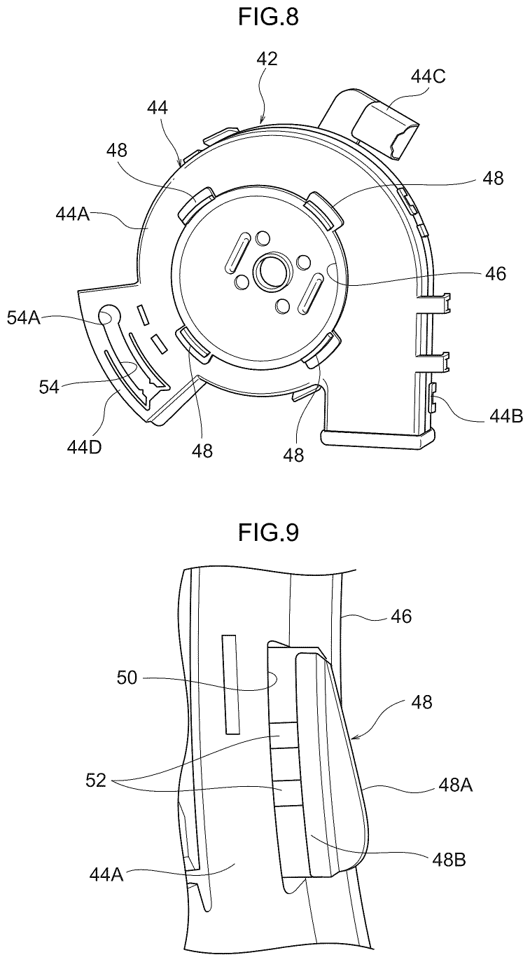

As illustrated in FIGS. 7 and 8, a case 44 of the blower 42 includes a substantially disk-shaped case body 44A whose axial direction is the front-rear direction. In the case body 44A, a sirocco fan (not illustrated) and a motor that rotates the sirocco fan are accommodated. In a front surface of the case body 44A, an intake port 46 having a circular shape as viewed in the front-rear direction is formed.

On an outer peripheral portion of the case body 44A, an exhaust pipe portion 44B protruding outward in the radial direction of the case body 44A is provided. As illustrated in FIG. 3, the exhaust pipe portion 44B is provided so as to protrude downward from a lower left portion of the case body 44A in a state where the case body 44A of the blower 42 is mounted to the duct 26. An exhaust port (not illustrated) is formed at a tip of the exhaust pipe portion 44B.

On an outer peripheral portion of the case body 44A, a connector portion 44C protruding outward in the radial direction of the case body 44A is provided. As illustrated in FIG. 3, the connector portion 44C is provided so as to protrude upward and leftward from an upper left portion of the case body 44A in a state where the case body 44A of the blower 42 is mounted to the duct 26. A connector (not illustrated) mounted to a wiring (not illustrated) for configuring electric power for the motor is connected to the connector portion 44C.

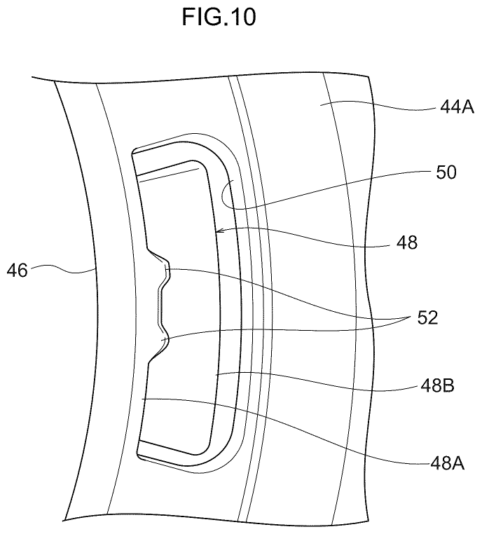

As illustrated in FIGS. 8 to 10, plural (here, four) locking claws 48 are formed at a hole edge portion of the intake port 46 on the front surface of the case body 44A. The plural locking claws 48 are arranged side by side at equal intervals in a circumferential direction of the case body 44A. Each locking claw 48 protrudes forward (that is, one side in the axial direction of the case body 44A) from the front surface of the case body 44A. At a portion where each locking claw 48 is formed at the edge of the intake port 46, a through hole 50 (see FIG. 10) for forming each locking claw 48 is formed.

Each of the locking claws 48 includes a plate-like front protruding portion 48A whose longitudinal direction is the circumferential direction of the case body 44A and whose plate thickness direction is the radial direction of the case body 44A, and an outward protruding portion 48B protruding from an intermediate portion of the front protruding portion 48A in the front-rear direction toward the radially outer side of the case body 44A. As illustrated in FIG. 9, two protrusions 52 protruding outward in the radial direction of the case body 44A are formed at a proximal end of the front protruding portion 48A. The two protrusions 52 are arranged at intervals in the circumferential direction of the case body 44A.

As illustrated in FIGS. 7 and 8, a lock portion 44D protruding outward in the radial direction of the case body 44A is provided on the outer peripheral portion of the case body 44A. The lock portion 44D has a substantially rectangular plate shape in which the circumferential direction of the case body 44A is the longitudinal direction and the axial direction of the case body 44A is the plate thickness direction. The lock portion 44D is disposed at a position spaced apart from the above-described exhaust pipe portion 44B in the circumferential direction of the case body 44A. As illustrated in FIG. 3, the lock portion 44D is provided so as to protrude downward and rightward from a lower right portion of the case body 44A in a state where the case body 44A of the blower 42 is mounted to the duct 26.

In the lock portion 44D, a elongated hole 54 whose longitudinal direction is the circumferential direction of the case body 44A is formed. The elongated hole 54 is curved concentrically with the case body 44A. At one end of the elongated hole 54 in the longitudinal direction, a widened portion 54A having a substantially circular shape as viewed in the front-rear direction is formed. The width of the elongated hole 54 is enlarged in the widened portion 54A.

On another end side in the longitudinal direction of the elongated hole 54, an inner slit 56A and an outer slit 56B are formed. The inner slit 56A is disposed on a radially inner side of the case body 44A with respect to a center portion in the longitudinal direction and another end in the longitudinal direction of the elongated hole 54, and extends in the longitudinal direction of the elongated hole 54. The outer slit 56B is disposed on a radially outer side of the case body 44A with respect to the center portion in the longitudinal direction and the other end in the longitudinal direction of the elongated hole 54, and extends in the longitudinal direction of the elongated hole 54. The inner slit 56A and the outer slit 56B are connected to the other end of the elongated hole 54 in the longitudinal direction.

An inner elastic piece 58A is formed between the elongated hole 54 and the inner slit 56A, and an outer elastic piece 58B is formed between the elongated hole 54 and the outer slit 56B. The inner elastic piece 58A and the outer elastic piece 58B are elastically deformable in the radial direction of the case body 44A. A projecting portion 60 protruding toward the elongated hole 54 is formed at each tip of the inner elastic piece 58A and the outer elastic piece 58B.

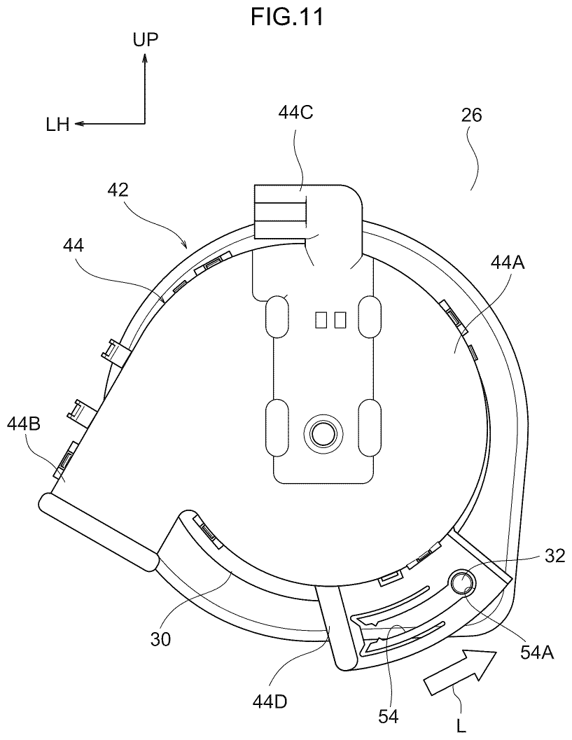

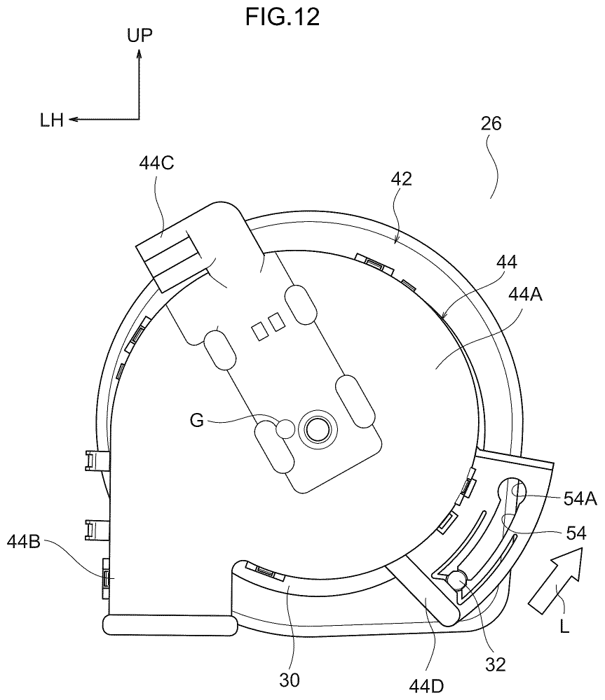

When the blower 42 having the above configuration is mounted to the blower mounting member 30, the plural locking claws 48 of the case 44 are fitted into the plural cutouts 36A of the blower mounting hole 36, and the projection 32 of the blower mounting member 30 is inserted into the widened portion 54A of the elongated hole 54 of the lock portion 44D (see FIG. 11). In this state, the blower 42 rotates about one axis of the blower mounting hole 36 (in this case, in the counterclockwise direction as viewed from the rear side (see arrow L in FIG. 12).

By the above rotation, the outward protruding portions 48B of the plural locking claws 48 are caught from the front side with respect to the hole edge portion of the blower mounting hole 36, and the hole edge portion of the blower mounting member 30 is sandwiched between the outward protruding portion 48B of each locking claw 48 and the case body 44A. Thus, the blower 42 is restrained in the front-rear direction with respect to the blower mounting member 30.

The protrusion 38A formed on each blower locking claw 38 of the blower mounting member 30 is fitted between the two protrusions 52 formed on the front protruding portion 48A of each locking claw 48. At the time of this fitting, each blower locking portion 38 elastically deforms radially outward of the blower mounting hole 36 and then elastically returns. By this fitting, the blower 42 is restrained in the circumferential direction of the blower mounting hole 36 with respect to the blower mounting member 30.

Further, due to the above rotation, the projection 32 of the blower mounting member 30 is arranged at the other end in the longitudinal direction of the elongated hole 54 of the lock portion 44D, and each projecting portion 60 of the inner elastic piece 58A and the outer elastic piece 58B is caught by the projection 32. At this time, the inner elastic piece 58A and the outer elastic piece 58B elastically return after being elastically deformed to the opposite sides. By being caught in this manner, the projection 32 is held at the other end of the elongated hole 54 in the longitudinal direction, and the lock portion 44D is locked (restrained) to the projection 32. Accordingly, the mounting of the blower 42 to the blower mounting member 30 is completed.

As illustrated in FIG. 12, the center of gravity G of the blower 42 that has been mounted to the blower mounting member 30 is disposed slightly eccentrically to the left side. The center of gravity G of the blower 42 is set at a position at which a rotational force acts on the blower 42 in one direction (arrow L direction in FIG. 12) about the axis of the blower mounting hole 36.

In the vehicle seat 10 having the above configuration, the back of the occupant seated on the seat cushion 12 is supported by the seat back 14. The blower mounting member 30 disposed in the seat back 14 is provided with the blower mounting hole 36 and the locking portion. The blower 42 is fitted into the blower mounting hole 36. The blower 42 is mounted to the blower mounting member 30 by being rotated in one direction (direction of arrow L in FIG. 12) about the axis of the blower mounting hole 36 in a state where the plural locking claws 48 of the case 44 are fitted into the plural cutouts 36A of the blower mounting hole 36. By this rotation, the lock portion 44D provided on the blower 42 is locked to the projection 32 provided on the blower mounting member 30.

The center of gravity G of the blower 42 is set at a position at which a rotational force about the axis in one direction acts on the blower 42. Thus, when vibration or the like during traveling of the vehicle is applied to the blower 42, the blower 42 attempts to rotate about the axis in one direction with respect to the blower mounting member 30 (that is, a direction in which the lock portion 44D is locked to the projection 32). That is, since the rotation direction of the blower 42 by the position of the center of gravity G and the locking direction of the blower 42 with respect to the blower mounting member 30 are set to the same direction, it is possible to prevent the blower 42 from being unintentionally unlocked from the blower mounting member 30.

In the embodiment, when the blower 42 is fitted into the blower mounting hole 36 of the blower mounting member 30, the projection 32 is inserted into the widened portion 54A formed at one end in the longitudinal direction of the elongated hole 54 of the lock portion 44D. When the blower 42 is rotated in one direction about the axis of the blower mounting hole 36, the projection is disposed at the other end of the elongated hole 54 in the longitudinal direction, and the projection 32 is held at the other end of the elongated hole 54 in the longitudinal direction.

With the above configuration, when the plural locking claws 48 of the blower 42 are fitted into the plural cutouts 36A of the blower mounting hole 36, the plural locking claws 48 can be arranged at fitting positions with respect to the plural cutouts 36A by aligning the widened portion 54A of the elongated hole 54 and the projection 32. That is, since the widened portion 54A and the projection 32 function as marks for alignment when the blower 42 is mounted to the blower mounting member 30, the operation of attaching the blower 42 to the blower mounting member 30 is facilitated.

Although the present disclosure has been described with reference to the embodiments, the disclosure can be variously modified without departing from the scope of the disclosure. It is a matter of course that the scope of rights of the disclosure is not limited to the above embodiments.

What is claimed is:

1. A blower mounting structure for a vehicle seat, the structure comprising:
a blower mounting member disposed in a seat back of the vehicle seat and provided with a blower mounting hole and a locking portion; and
a blower that is mounted to the blower mounting member by being subjected to rotation in one direction about an axis of the blower mounting hole in a state of being fitted into the blower mounting hole, and having a lock portion that is locked to the locking portion by the rotation,
wherein a center of gravity of the blower is set at a position at which a rotational force in the one direction about the axis acts on the blower.

2. The blower mounting structure for a vehicle seat according to claim 1, wherein:
the blower mounting structure is configured such that the locking portion is a projection,
the lock portion has an elongated hole, and
the projection is inserted into one end of the elongated hole in a longitudinal direction of the hole when the blower is fitted into the blower mounting hole, and the projection is held at another end of the elongated hole in the longitudinal direction by being disposed, by the rotation, at the other end of the elongated hole in the longitudinal direction.

3. A vehicle seat, comprising:
a seat cushion on which an occupant is seated; and
a seat back that supports a back of the occupant and that has the blower mounting structure for a vehicle seat according to claim 1.
